(19) United States
(12) Patent Application Publication
(10) Pub. No.: US 2005/0010595 A1
(43) Pub. Date: Jan. 13, 2005

(54) System and method for automating an identification mechanism and type information configuration process for a real-time data feed to a database

(75) Inventors: Kevin Brown, San Rafael, CA (US); Michael John Elvery Spicer, Lafayette, CA (US)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 10/618,407

(22) Filed: Jul. 11, 2003

(51) Int. Cl. G06F 17/00

(52) U.S. Cl. 707/104.1

(57) ABSTRACT

A type information configuration process automatically determines type information for all real-time data feeds being loaded into a relational database system (RDBMS). The automatic type information configuration system reduces the complexity of configuration while improving reliability and maintainability of the RDBMS. This system also removes the need for an additional database table and the resources associated with that additional database. The configuration of the real-time feed loader details the table and column of the data stream to be loaded by each data feed. The data stream is created based on the type it is expected to hold. The sub-type of the data stream is held in an encoded form in the systems catalogs of the database server. The present system accesses and decodes this subtype information based on the column and table in the configuration file to automatically find the type being loaded by the data feed.

### FIELD OF THE INVENTION

The present invention generally relates to processing of data streams in real-time. More specifically, this invention pertains to a method for automatically creating triggers required for the columns and tables in the data streams that are being loaded, and for automatically determining the type information for a data stream entity without the use of a type map table.

### BACKGROUND OF THE INVENTION

The time-based data from a real-time feed is typically being transferred to a database such as a relational data base management system, RDBMS. One example of such a real-time stream of data would be quotes on stocks being traded. Within the RDBMS, data is organized such that it can be easily found. For example, if a user were to request a quote for IBM stock, the price would be quickly found. The RDBMS uses an area of shared memory attached to the database server to load and query high volumes of data in real-time. The data records being loaded can be of different types for different data feeds being ingested.

The RDBMS uses the area of shared memory attached to the database server to load and query high volumes of data in real-time. Each data record being received contains data about a specific entity such as IBM stock, for example. When a data record is received for an entity that is not already known to the system, a new entity is created in both shared memory and in the database. The shared memory entity record requires details identifying the location of the database record to allow fast access and load for all future data records for that entity. This update of the shared memory identification is performed using a database trigger.

Currently, the need is recognized by the RDBMS for the triggers, but the burden is placed on the user to manually configure these triggers. In many cases the triggers were not created or created incorrectly which resulted in additional processing to retrieve the database identifier through an additional SQL select statement, which is a relatively expensive operation in terms of processing time.

In addition, the need is currently recognized by the RDBMS for the type information, but again the burden is placed on the user to configure this information manually by using an additional database table called the type map. The type map holds an identification (ID) and a string representation of the type name. The ID references the type ID for each feed in the configuration file. The use of a type map allows the RDBMS access to type information at the cost of increased complexity of setup and increased resource usage for an additional table. In many cases, users have experienced problems where the type map table and the configuration file were not in sync, resulting in user confusion and frustration in addition to calls to the vendor for technical support or help.

Requiring the user to manually configure the triggers and the type map table increases the complexity of the setup, increases maintenance, and increases the likelihood of serious errors. These errors may result in additional technical support cases and a bad user experience.

What is therefore needed is a system and associated method for automating the identification mechanism and type information configuration within the RDBMS. The need for such system and method has heretofore remained unsatisfied.

### SUMMARY OF THE INVENTION

The present invention satisfies this need, and presents a system, a computer program product, and an associated method (collectively referred to herein as “the system” or “the present system”) for automating the identification mechanism and type information configuration process for all real-time data feeds being loaded. The present system automatically creates various triggers required for all columns and tables being loaded. The present system also renders obsolete the need for an additional database table and the resources associated with that additional database, and further negates the need for the relatively expensive select statement used to discover triggers when the manual configuration of triggers failed. Automating the trigger creation and type information configuration reduces the complexity of manual configuration by the user while improving reliability and maintainability of the RDBMS.

Each data feed loaded in the database has a corresponding entry in a shared memory that contains the identifier of the database entry. The shared memory record is updated with the database identifier by a database trigger. There can be more than one data feed being loaded in a single row. Consequently, both the insert and the update triggers covering each data feed column being loaded are required.

The configuration of the real-time feed loader details the table and column of the data stream to be loaded by each data feed. The data stream is created based on the type it is expected to hold. The sub-type of the data stream is held in an encoded form in the systems catalogs of the database server. The present system accesses and decodes this subtype information based on the column and table in the configuration file to automatically find the type being loaded by the data feed.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which an automatic identification mechanism and type information configuration system of the present invention can be used;

FIG. 2 is a more detailed block diagram of the high-level architecture of the automatic identification mechanism and type information configuration system of FIG. 1;

FIG. 3 is a process flow chart illustrating a method of operation of the automatic type information configuration system of FIGS. 1 and 2; and

FIG. 4 is comprised of FIGS. 4A, 4B, and 4C, and represents a process flow chart illustrating a method of operation of the system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

API: (Application Program Interface) A language and message format used by an application program to communicate with the operating system or some other system or control program such as a database management system (DBMS) or communications protocol.

Data stream: A flow of data from one place to another.

Feed: The data stream input to a computer program.

Internet: A collection of interconnected public and private computer networks that are linked together with routers by a set of standard protocols to form a global, distributed network.

SQL: Structured Query Language, a standardized query language for requesting information from a database.

World Wide Web (WWW, also Web): An Internet client-server hypertext distributed information retrieval system.

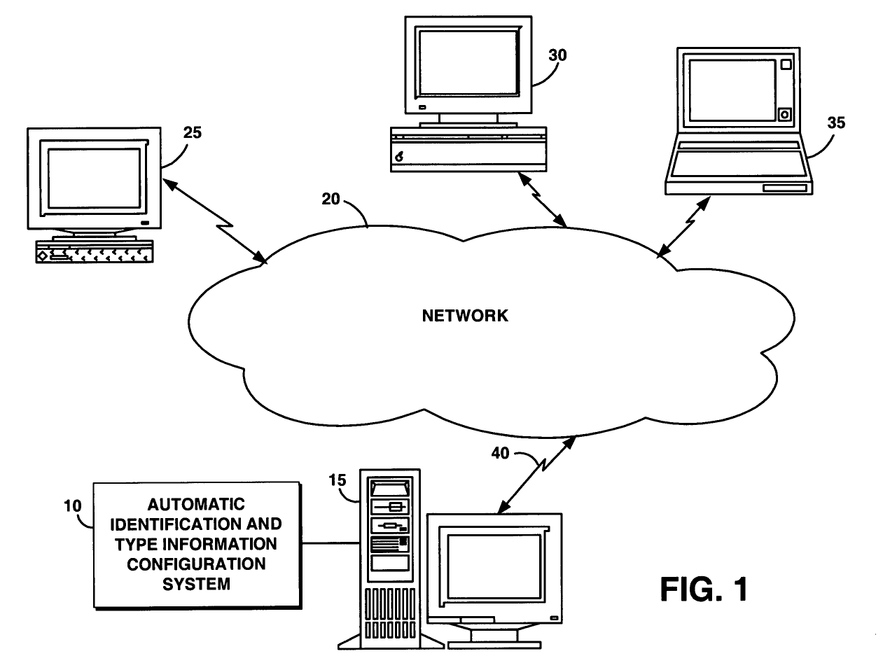

FIG. 1 portrays an exemplary overall environment in which a system and method for automatically determining the type information for a data stream entity without the use of a type map table may be used according to the present invention. System 10 includes a software programming code or computer program product that is typically embedded within, or installed on a host server 15. Alternatively, system 10 can be saved on a suitable storage medium such as a diskette, a CD, a hard drive, or like devices. While the system 10 will be described in connection with the WWW, the system 10 can be used with a stand-alone database of terms that may have been derived from the WWW and/or other sources.

The cloud-like network 20 may be comprised of communication lines and switches. The network 20 provides the communication access to, for example, the WWW or Internet. Users, such as remote Internet users, are represented by a variety of computers such as computers 25, 30, 35, and can query the host server 15 for desired information through the network 20. Each of computers 25, 30, 35 includes software that will allow the user to interface securely with the host server 15. The host server 15 can be connected to the network 20 via a communications link 40 such as a telephone, cable, satellite link, or like connections.

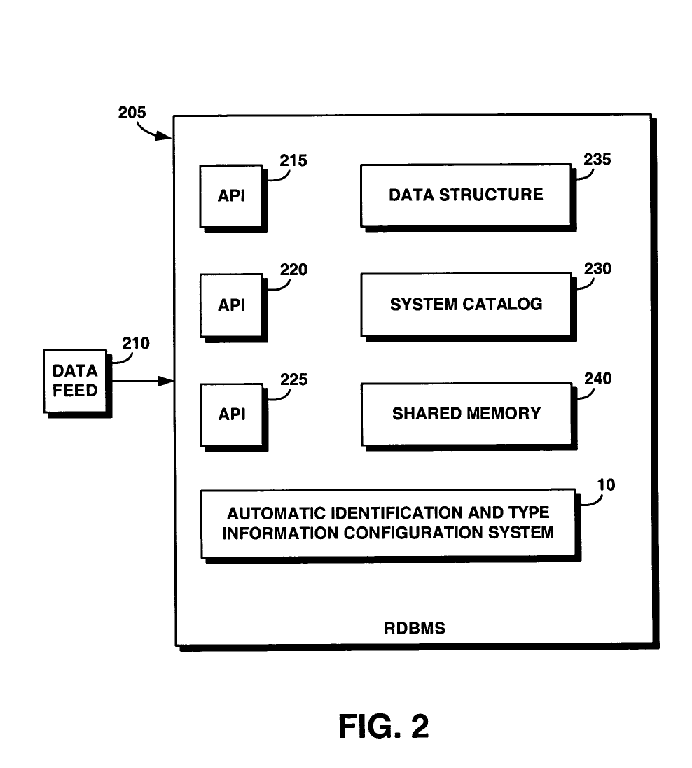

The block diagram of FIG. 2 illustrates a high-level architecture of an exemplary relational database system (RDBMS) 205 in which system 10 may be used. A data feed 210 continually provides data to the RDBMS 205. The RDBMS 205 comprises several application program interfaces (APIs) such as API 215, API 220, and API 225. API 215, API 220, and API 225 are representative of APIs that might be used by system 10 to achieve automatic type information configuration; any other APIs or methods that achieve the same result may be used. RDBMS 205 also comprises a system catalog 230, a data structure 235, and a shared memory 240.

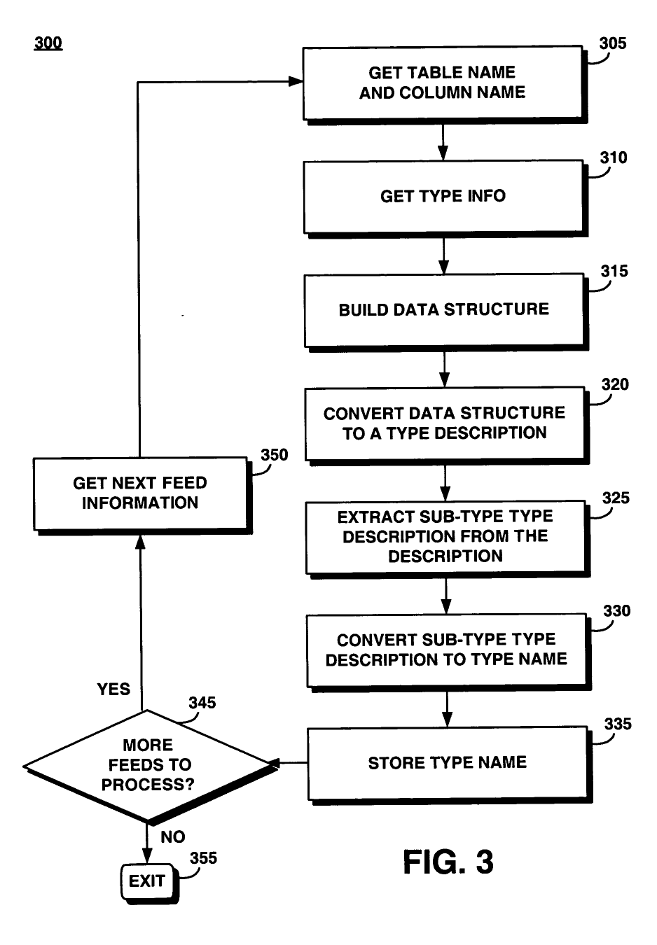

A method of operation 300 of system 10 is illustrated in the process flow chart of FIG. 3. Written in pseudocode, method 300 can be summarized as follows:

```
  For each feed
    get the table name and column name being populated by the feed
    get the type info from the system catalog for feed_table and
feed_column using the following SQL statement
      “select x.type, x.extended_id
        from syscolumns s, systables t, sysxtdtypes x
        where s.tabid = t.tabid and s.extended_id = x.extended_id
          and x.mode =‘S’ and LOWER(tabname) =
LOWER(‘feed_table’)
          and LOWER(s.colname) = LOWER(‘feed_column’);”
    build an MI_TYPE_ID structure from the type and extended_id
retrieved above.
    convert the MI_TYPE_ID to a type descriptor using API 215
    extract the sub-type descriptor from the type descriptor using
API 220
    convert the sub-type descriptor to the type name using API 225
    store the type name for that feed
  End For each feed
```

Method 300 is performed for each data feed 210. At block 305, system 10 gets the table name and column name being populated by data feed 210. At block 310, system 10 gets the type information from the system catalog 235 for the table and column found at block 305. Type information is found using an SQL statement to query the system catalog 235. This SQL statement obtains the type and extended_id of the data feed.

From the type and extended_id of the data feed, system 10 builds a data structure 235 such as an MI_Type_ID structure (block 315). System 10 converts the data structure 235 to a type descriptor using API 215 at block 320. One example of such an API as API 215 would be mi_type_typedesc. System extracts the sub-type descriptor from the type descriptor using API 220 at block 325. One example of such an API as API 220 would be mi_type_element_typedesc.

At block 330, system 10 converts the sub-type descriptor to the type name using API 225. One example of such an API as API 225 would be mi_type_typename. System 10 stores the type name for data feed 210 at block 335. At decision block 345, system 10 determines whether additional feeds are available for processing. If yes, system 10 gets the next feed information at block 350, and then repeats blocks 305 through 345 for each data feed 210. Otherwise, system 10 exits process 300 at block 355.

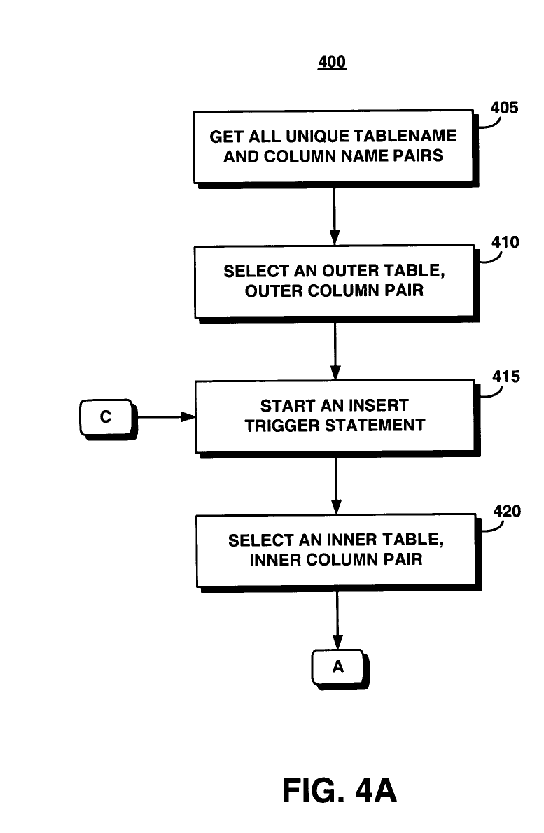

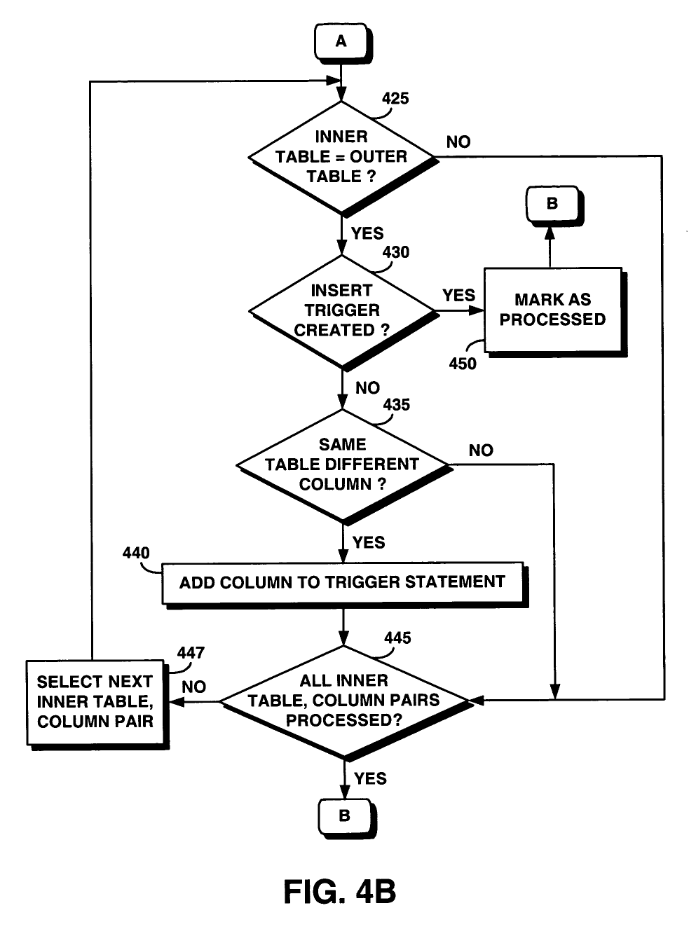

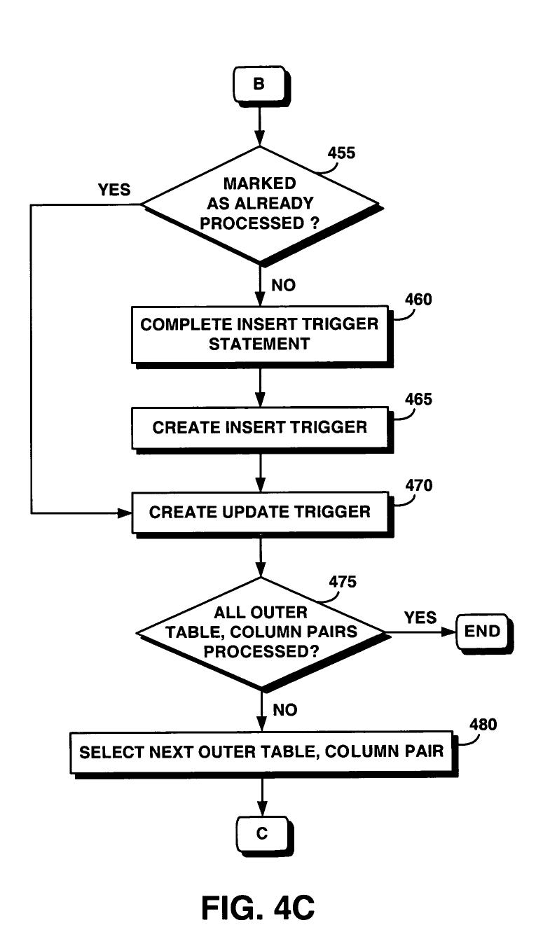

A method of operation 400 of system 10 is illustrated in the process flow chart of FIG. 4 (FIGS. 4A, 4B, 4C). The loader configuration details the table and column of the data stream to be loaded by each data feed 210. System 10 automatically creates in method 400 all triggers required for all columns and tables being loaded. Written in pseudocode, method 400 can be summarized as follows:

```
  Get all unique table name and column name pairs being populated by
the feeds
  For each table, column pair (outer_tab, outer_col)
    Start an insert trigger statement as follows:
      “CREATE TRIGGER rtl_insert_trigger_outer_tab_outer_{—}
col INSERT ON outer_tab
        REFERENCING NEW AS post
        FOR EACH ROW”
        (EXECUTE PROCEDURE WriteRtlInstId(post.outer_col)”
    For each table, column pair (inner_tab, inner_col)
      if inner_tab = outer_tab then
        if this table has already had an insert trigger created
then
          mark it as already processed and break out of inner
loop
        else if this is for the same table but a different column
then
          add this column to the trigger statement by
concatenating the following to the insert trigger statement above :
        “, EXECUTE PROCEDURE WriteRtlInstId(post.inner_col)”
        end if
      end if inner_tab = outer_tab
    End For each table, column pair
    if not marked as already processed then
      complete the insert trigger statement by concatenating “)” to
the end
      create the insert trigger by executing the insert trigger
statement end if Create an update trigger for the column using a
statement as follows :
    “CREATE TRIGGER rtl_update_trigger_outer_tab_outer_{—}
col UPDATE OF outer_col ON outer_tab
      REFERENCING OLD AS pre NEW AS post
      FOR EACH ROW WHEN (pre.outer_col IS NULL AND
post.outer_col IS NOT NULL) ”
      (EXECUTE PROCEDURE WriteRtlInstId(post.outer_col))”
    End For each table, column pair
```

Method 400 is performed for each data feed 210. At block 405, system 10 obtains all unique table name and column name pairs being populated by the data feed 210. System 10 selects one outer table and outer column pair at block 410. At block 415, system 10 starts an insert trigger statement.

System 10 selects an inner table and inner column pair at block 420. If at decision block 425 (FIG. 4B), the inner table is equivalent to the outer table, system 10 proceeds to decision block 430 and determines whether an insert trigger has been created for this inner table and inner column pair.

If at decision block 430 system 10 determines that an insert trigger has not been created for the inner table and inner column pair, system 10 checks whether the pair being processed is the same table, but different column at decision block 435. This identifies all columns for a given table required for the insert to trigger. If the result of decision block 435 is yes, system 10 adds the inner column to the trigger statement at block 440. If additional inner table or column pairs remain to be processed at decision block 445, system 10 selects the next inner table and inner column pair at block 447 and, returns to decision block 425.

If at decision block 435 the result is no, system 10 proceeds to decision block 445, and determines if additional table and column pairs remain to be processed, as discussed above.

If at decision block 430 an insert trigger had been created for the inner table, column pair, system 10 marks the inner table, column pair as processed (block 450) and proceeds to decision block 455, FIG. 4C.

When the inner table and inner column pairs for the outer column and outer table pairs have been processed (decision block 445) or an insert trigger has been created (decision block 430), system 10 proceeds to decision block 455 (FIG. 4C). If the outer table and outer column pair have not been marked as already processed, system 10 completes the insert trigger statement (block 460).

System 10 creates an insert trigger at block 465 and creates an update trigger at block 470. If at decision block 455 the outer table, column pair have been marked as already processed, system 10 proceeds directly to block 470 and creates an update trigger. At decision block 475, system 10 determines if all the outer table and column pairs have been processed. If yes, method 400 is complete. Otherwise, system 10 selects the next outer table, column pair (block 480), and returns to block 415 (FIG. 4A).

It is to be understood that the specific embodiments of the invention that have been described are merely illustrative of certain applications of the principle of the present invention. Numerous modifications may be made to the system and method for automating the identification mechanism and type information configuration process for a real-time data feed to a database invention described herein without departing from the spirit and scope of the present invention. Moreover, while the present invention is described for illustration purpose only in relation to the WWW, it should be clear that the invention is applicable as well to databases contrived from systems linked, for example, through local area networks, wide area networks, etc., and to stand-alone systems.

1. A method of automating an identification and type information configuration for a real-time data feed, comprising:
automatically creating trigger statements for the real-time data feed; and
automatically deriving a type information for the real-time data feed from a column being loaded.

2. The method of claim 1, wherein the trigger statements comprise an insert trigger.

3. The method of claim 1, wherein the trigger statements comprise a plurality of update triggers.

4. The method of claim 1, wherein the feed is loaded to a database; and
further comprising building a data structure for a database trigger.

5. The method of claim 4, further comprising converting the data structure to a type descriptor, in order to identify a type of data that the data structure is expected to hold.

6. The method of claim 5, further comprising extracting a sub-type descriptor from the type descriptor, to automatically find the type of data being loaded by the real-time data feed.

7. The method of claim 6, further comprising storing the type name for the data feed, to automatically find the type of data being loaded by the real-time data feed.

8. The method of claim 1, further comprising getting a table name and a column name being populated by the real-time data feed.

9. The method of claim 4, wherein the type information and an extended identification that is referred to as extended-id, are obtained from a system catalog to build the data structure.

10. The method of claim 1, further comprising getting a plurality of unique pairs of a plurality of table names and a plurality of column names for which triggers will be automatically created.

11. A system for automating an identification and type information configuration for a real-time data feed, comprising:
means for automatically creating trigger statements for the real-time data feed; and
means for automatically deriving a type information for the real-time data feed from a column being loaded.

12. The system of claim 11, wherein the trigger statements comprise an insert trigger.

13. The system of claim 11, wherein the trigger statements comprise a plurality of update triggers.

14. The system of claim 11, wherein the feed is loaded to a database; and
further comprising means for building a data structure for a database trigger.

15. The system of claim 14, further comprising means for converting the data structure to a type descriptor, in order to identify a type of data that the data structure is expected to hold.

16. The system of claim 15, further comprising means for extracting a sub-type descriptor from the type descriptor, to automatically find the type of data being loaded by the real-time data feed.

17. The system of claim 16, further comprising means for storing the type name for the data feed, to automatically find the type of data being loaded by the real-time data feed.

18. The system of claim 11, further comprising means for getting a table name and a column name being populated by the real-time data feed.

19. The system of claim 14, wherein the type information and an extended identification that is referred to as extended-id, are obtained from a system catalog to build the data structure.

20. The system of claim 11, further comprising means for getting a plurality of unique pairs of a plurality of table names and a plurality of column names for which triggers will be automatically created.

21. A computer program product having instruction codes embedded on a medium for automating an identification and type information configuration for a real-time data feed, comprising:
a first set of instruction codes for automatically creating trigger statements for the real-time data feed; and
a second set of instruction codes for automatically deriving a type information for the real-time data feed from a column being loaded.

22. The computer program product of claim 21, wherein the trigger statements comprise an insert trigger.

23. The computer program product of claim 21, wherein the trigger statements comprise a plurality of update triggers.

24. The computer program product of claim 21, wherein the feed is loaded to a database; and
further comprising a third set of instruction codes for building a data structure for a database trigger.

25. The computer program product of claim 24, further comprising a fourth set of instruction codes for converting the data structure to a type descriptor, in order to identify a type of data that the data structure is expected to hold.

26. The computer program product of claim 25, further comprising a fifth set of instruction codes for extracting a sub-type descriptor from the type descriptor, to automatically find the type of data being loaded by the real-time data feed.

27. The computer program product of claim 26, further comprising a sixth set of instruction codes for storing the type name for the data feed, to automatically find the type of data being loaded by the real-time data feed.

28. The computer program product of claim 21, further comprising a seventh set of instruction codes for getting a table name and a column name being populated by the real-time data feed.

29. The computer program product of claim 24, wherein the type information and an extended identification that is referred to as extended-id, are obtained from a system catalog to build the data structure.

30. The computer program product of claim 21, further comprising an eight set of instruction codes for getting a plurality of unique pairs of a plurality of table names and a plurality of column names for which triggers will be automatically created.
